(19) United States
(12) Patent Application Publication
(10) Pub. No.: US 2026/0361367 A1
(43) Pub. Date: Nov. 12, 2026

(54) CSI-RELATED METHOD AND APPARATUS IN NODE USED FOR WIRELESS COMMUNICATION

(71) Applicant: HONOR DEVICE CO., LTD., Shenzhen (CN)

(72) Inventors: Yang Hu, Shenzhen (CN); Lu Wu, Shenzhen (CN); Xiaobo Zhang, Shenzhen (CN)

(73) Assignee: HONOR DEVICE CO., LTD., Shenzhen (CN)

(21) Appl. No.: 19/745,273

(22) Filed: Jul. 17, 2026

Related U.S. Application Data
(63) Continuation of application No. PCT/CN2025/072890, filed on Jan. 17, 2025.

(30) Foreign Application Priority Data
Jan. 19, 2024 (CN) 202410078093.3

(51) Int. Cl. H04B 7/06

(52) U.S. Cl. CPC H04B 7/0626; H04B 7/0632

(57) ABSTRACT

A channel state information (CSI) related method and apparatus in a node used for wireless communication are provided. A first receiving apparatus receives a first signal of a first wireless access technology, and a first transmitting apparatus sends target CSI of a second wireless access technology, where determining of the target CSI depends on the first signal, the first wireless access technology is different from the second wireless access technology, and the second wireless access technology is a cellular network wireless access technology.

### CROSS-REFERENCE TO RELATED APPLICATIONS

This application is a continuation of International Application No. PCT/CN 2025/072890, filed on Jan. 17, 2025, which claims priority to Chinese Patent Application No. 2024100780933, filed on Jan. 19, 2024, both of which are incorporated herein by reference in their entireties.

### TECHNICAL FIELD

This application relates to a transmission method and apparatus in a wireless communication system, and in particular, to a method and apparatus for transmitting a wireless signal in a wireless communication system supporting a cellular network.

### BACKGROUND

In the future, a wireless communication network requires a human-centric approach as development vision to meet communication demands of high reliability, a low latency, a service with a high transmission rate, a high system coverage, and interconnection of all things. Resource sharing among different wireless access technologies is regarded as an important aspect of the wireless communication network in the future.

In wireless communication, communication performance is directly dependent on obtaining of channel information. For a wireless access technology, obtaining more channel information helps improve communication performance.

### SUMMARY

How to perform resource sharing among a plurality of wireless access technologies is an important problem that needs to be considered for enhancing a communication network. This application discloses a solution to the foregoing problem. It should be noted that this application is applicable to various wireless communication scenarios, such as a mobile communication network, a wireless local area network, a vehicular network, and an Internet of Things, and achieves similar technical effects. Moreover, using a unified solution across different scenarios (including but not limited to the mobile communication network, the wireless local area network, the vehicular network, and the Internet of Things) also helps reduce hardware complexity and costs, or improve performance. In a case of no conflict, embodiments and features in embodiments of any node in this application can be applied to any other node. In a case of no conflict, embodiments of this application and the features in embodiments may be arbitrarily combined with each other.

If necessary, interpretation of terms in this application may refer to the descriptions in the TS37 series, TS38 series, and a series of a higher version of the 3GPP (3rd Generation Partnership Project) specification documents.

This application discloses a method in a first node used for wireless communication, including:
receiving a first signal of a first wireless access technology; and
sending target CSI of a second wireless access technology, where
determining of the target CSI depends on the first signal, the first wireless access technology is different from the second wireless access technology, and the second wireless access technology is a cellular network wireless access technology.

In an embodiment, a problem to be resolved by this application includes how to enhance CSI (channel status information) reporting.

In an embodiment, a problem to be resolved by this application includes how to improve efficiency of a heterogeneous network.

In an embodiment, benefits of the method include: facilitating full use of a shared resource (for example, the first signal) in a heterogeneous network to enhance CSI reporting.

In an embodiment, benefits of the method include: facilitating improvement of resource use efficiency.

In an embodiment, benefits of the method include: facilitating network optimization.

In an embodiment, benefits of the method include: facilitating cooperation among a plurality of wireless access technologies to improve wireless network performance.

According to an aspect of this application, the method is characterized in that
the target CSI includes a target CQI, and determining of the target CQI depends on measurement of the first signal.

In an embodiment, benefits of the method include: facilitating improvement of transmission performance of scheduling based on the target CQI (channel quality indicator).

According to an aspect of this application, the method is characterized in that
the first signal is used for channel measurement, and the determining of the target CSI depends on measurement of the first signal.

In an embodiment, in combination with the foregoing features, benefits of the solutions disclosed in this application include: improvement of configuration flexibility of channel measurement for CSI reporting, and facilitating improvement of performance of channel estimation or saving resources used for channel measurement.

According to an aspect of this application, the method is characterized in that
the determining of the target CSI depends on a first generator, and a result obtained by measuring the first signal is used for training of the first generator.

In an embodiment, benefits of the method include: facilitating improvement of precision of CSI reporting by using AI (artificial intelligence) and ML (machine learning) technologies.

According to an aspect of this application, the method is characterized in that
an input of a first generator depends on measurement of the first signal, the target CSI includes at least a part of an output corresponding to the input, and the first generator is obtained through training.

In an embodiment, benefits of the method include: facilitating improvement of precision of CSI reporting by using an AI or ML technology.

According to an aspect of this application, the method is characterized in that
first signaling of the second wireless access technology is received, and the first signaling indicates reporting of the target CSI.

According to an aspect of this application, the method is characterized in that
the first wireless access technology is a non-cellular network wireless access technology.

This application discloses a method in a second node used for wireless communication, including:
sending a first signal of a first wireless access technology; and
receiving target CSI of a second wireless access technology, where
determining of the target CSI depends on the first signal, the first wireless access technology is different from the second wireless access technology, and the second wireless access technology is a cellular network wireless access technology.

According to an aspect of this application, the method is characterized in that
the target CSI includes a target CQI, and determining of the target CQI depends on measurement of the first signal.

According to an aspect of this application, the method is characterized in that
the first signal is used for channel measurement, and the determining of the target CSI depends on measurement of the first signal.

According to an aspect of this application, the method is characterized in that
the determining of the target CSI depends on a first generator, and a result obtained by measuring the first signal is used for training of the first generator.

According to an aspect of this application, the method is characterized in that
an input of a first generator depends on measurement of the first signal, the target CSI includes at least a part of an output corresponding to the input, and the first generator is obtained through training.

According to an aspect of this application, the method is characterized in that
first signaling of the second wireless access technology is sent, and the first signaling indicates reporting of the target CSI.

According to an aspect of this application, the method is characterized in that
the first wireless access technology is a non-cellular network wireless access technology.

This application discloses a first node used for wireless communication, including:
a first receiving apparatus, receiving a first signal of a first wireless access technology; and
a first transmitting apparatus, sending target CSI of a second wireless access technology, where
determining of the target CSI depends on the first signal, the first wireless access technology is different from the second wireless access technology, and the second wireless access technology is a cellular network wireless access technology.

This application discloses a second node used for wireless communication, including:
a second transmitting apparatus, sending a first signal of a first wireless access technology; and
a second receiving apparatus, receiving target CSI of a second wireless access technology, where
determining of the target CSI depends on the first signal, the first wireless access technology is different from the second wireless access technology, and the second wireless access technology is a cellular network wireless access technology.

### BRIEF DESCRIPTION OF DRAWINGS

Other features, objectives, and advantages of this application become more apparent by reading detailed descriptions of non-limiting embodiments with reference to the following drawings:

FIG. 1 is a flowchart of processing of a first node according to an embodiment of this application;

FIG. 2 is a flowchart of signal transmission according to an embodiment of this application;

FIG. 3 is a schematic diagram of determining of target CSI depending on a first signal according to an embodiment of this application;

FIG. 4 is a schematic diagram of determining of target CSI according to an embodiment of this application;

FIG. 5 is a flowchart of transmission of first channel information included in target CSI according to an embodiment of this application;

FIG. 6 is a schematic diagram of a first encoder according to an embodiment of this application;

FIG. 7 is a schematic diagram of a first function according to an embodiment of this application;

FIG. 8 is a schematic diagram of first signaling according to an embodiment of this application;

FIG. 9 is a block diagram of a structure of a processing apparatus in a first node device according to an embodiment of this application; and

FIG. 10 is a block diagram of a structure of a processing apparatus in a second node device according to an embodiment of this application.

### DETAILED DESCRIPTION OF EMBODIMENTS

The following further describes in detail the technical solutions in this application with reference to the accompanying drawings. It should be noted that, in a case of no conflict, embodiments of this application and the features in embodiments may be arbitrarily combined with each other.

### Embodiment 1

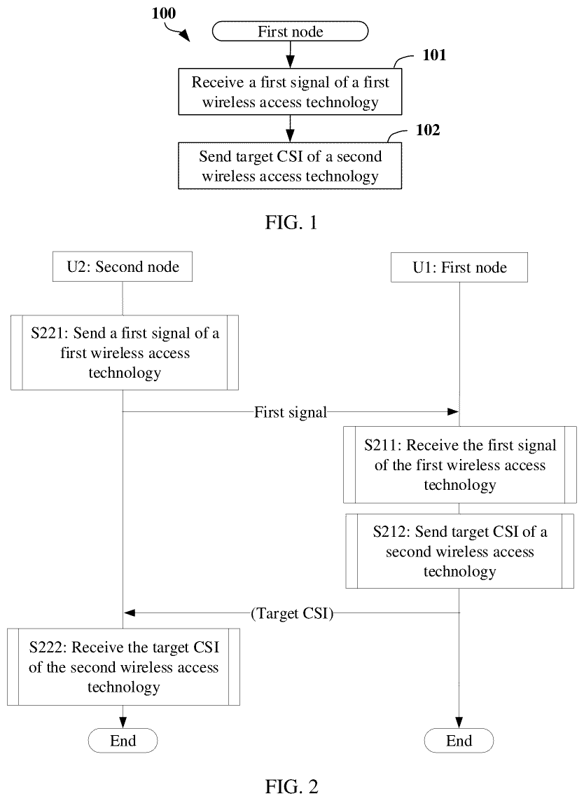

Embodiment 1 illustrates a flowchart of processing of a first node according to an embodiment of this application, as shown in FIG. 1.

In Embodiment 1, a first node in this application receives a first signal of a first wireless access technology in step 101, and sends target CSI of a second wireless access technology in step 102.

In Embodiment 1, determining of the target CSI depends on the first signal, the first wireless access technology is different from the second wireless access technology, and the second wireless access technology is a cellular network wireless access technology.

In an embodiment, the first signal is a wireless signal.

In an embodiment, the first signal is a radio frequency signal.

In an embodiment, the first signal is a baseband signal.

In an embodiment, the first signal is defined in technical specification of the first wireless access technology.

In an embodiment, the first signal is transmitted on a transmission resource defined in the first wireless access technology.

In an embodiment, the first signal is transmitted through a channel defined in the first wireless access technology.

In an embodiment, the first signal is transmitted by using the first wireless access technology.

In an embodiment, the target CSI is defined in technical specification of the second wireless access technology.

In an embodiment, content included in the target CSI is defined for the second wireless access technology.

In an embodiment, content included in the target CSI is configured by a parameter defined in the second wireless access technology.

In an embodiment, the target CSI belongs to UCI (uplink control information) in the second wireless access technology.

In an embodiment, benefits of the method include: facilitating ensurance of reporting timeliness of the target CSI.

In an embodiment, the determining of the target CSI depends on measurement of the first signal.

In a sub-embodiment of the foregoing embodiment, the first signal is used for channel measurement.

In a sub-embodiment of the foregoing embodiment, the first signal is used for interference measurement.

In an embodiment, in combination with the foregoing features, benefits of the solutions disclosed in this application include: improvement of configuration flexibility of measurement for CSI reporting.

In an embodiment, benefits of the method include: facilitating saving of resources used for measurement.

In an embodiment, the target CSI includes a result obtained by measuring the first signal.

In an embodiment, the target CSI includes a receiving power of the first signal.

In an embodiment, the target CSI includes an SINR calculated based on measurement of the first signal.

In an embodiment, the target CSI includes a target SINR. An effective signal power used in calculation of the target SINR is obtained by measuring at least one signal including the first signal.

In an embodiment, the first signal is used for channel measurement, and the determining of the target CSI depends on measurement of the first signal.

In a sub-embodiment of the foregoing embodiment, the target CSI includes a target CQI, and determining of the target CQI depends on measurement of the first signal.

In a sub-embodiment of the foregoing embodiment, the determining of the target CSI depends on a first generator, and a result obtained by measuring the first signal is used for training of the first generator.

In a sub-embodiment of the foregoing embodiment, an input of a first generator depends on measurement of the first signal, the target CSI includes at least a part of an output corresponding to the input, and the first generator is obtained through training.

In an embodiment, the target CSI includes a channel parameter obtained by measuring at least one signal including the first signal.

In an embodiment, the first signal is used for interference measurement, and the determining of the target CSI depends on measurement of the first signal.

In a sub-embodiment of the foregoing embodiment, the target CSI includes a target CQI, and determining of the target CQI depends on measurement of the first signal.

In a sub-embodiment of the foregoing embodiment, the determining of the target CSI depends on a first generator, and a result obtained by measuring the first signal is used for training of the first generator.

In a sub-embodiment of the foregoing embodiment, an input of a first generator depends on measurement of the first signal, the target CSI includes at least a part of an output corresponding to the input, and the first generator is obtained through training.

In an embodiment, benefits of the method include: facilitating improvement of reliability of CSI reporting.

In an embodiment, the target CSI includes a target SINR. An interference power used in calculation of the target SINR is obtained by measuring at least one signal including the first signal.

In an embodiment, the at least one signal including the first signal includes only the first signal.

In an embodiment, the at least one signal including the first signal further includes a signal of the first wireless access technology.

In an embodiment, the signal of the first wireless access technology is defined in technical specification of the first wireless access technology.

In an embodiment, the signal of the first wireless access technology is transmitted on a transmission resource defined in the first wireless access technology.

In an embodiment, the signal of the first wireless access technology is transmitted through a channel defined in the first wireless access technology.

In an embodiment, the signal of the first wireless access technology is transmitted by using the first wireless access technology.

In an embodiment, the at least one signal including the first signal further includes a signal of the second wireless access technology.

In an embodiment, benefits of the method include: facilitating full use of signals of a plurality of wireless access technologies to enhance CSI reporting.

In an embodiment, the signal of the second wireless access technology is defined in technical specification of the second wireless access technology.

In an embodiment, calculation of the target CSI depends on the first signal.

In an embodiment, the target CSI includes an SINR.

In an embodiment, the target CSI includes a CQI (channel quality indicator).

In an embodiment, the target CSI includes a CQI calculated based on measurement of at least the first signal.

In an embodiment, the target CSI includes precoding information.

In an embodiment, the target CSI is obtained by using an AI or ML method.

In an embodiment, the target CSI is obtained by using a method other than AI or ML.

In an embodiment, the target CSI is sent through a physical channel.

In an embodiment, the target CSI is sent after at least channel encoding.

In an embodiment, the target CSI is sent through a physical channel after at least channel encoding and modulation.

In an embodiment, the second wireless access technology is a cellular network wireless access technology, and the first wireless access technology is a non-cellular network wireless access technology.

In an embodiment, in combination with the foregoing features, the solutions disclosed in this application facilitate resource sharing between a cellular network and a non-cellular network.

In an embodiment, the first wireless access technology is a WLAN (wireless local area networks) wireless access technology.

In an embodiment, the first wireless access technology is a wifi wireless access technology.

In an embodiment, the first wireless access technology is a Bluetooth wireless access technology.

In an embodiment, the second wireless access technology is a mobile communication wireless access technology, and the first wireless access technology is a non-mobile communication wireless access technology.

In an embodiment, that the second wireless access technology is a cellular network wireless access technology includes a case that the second wireless access technology is a mobile communication wireless access technology.

In an embodiment, the second wireless access technology is a 5G (5th Generation Mobile Communication) wireless access technology.

In an embodiment, the second wireless access technology is a 6G (6th Generation Mobile Communication) wireless access technology.

In an embodiment, the second wireless access technology and the first wireless access technology are respectively wireless access technologies of different cellular networks.

In an embodiment, the first wireless access technology is a 5G wireless access technology, and the second wireless access technology is a 6G wireless access technology.

In an embodiment, the second wireless access technology is a 5G wireless access technology, and the first wireless access technology is a 6G wireless access technology.

In an embodiment, a transmit end of the first signal and a receive end of the target CSI are a same node.

In an embodiment, a transmit end of the first signal and a receive end of the target CSI are different nodes.

In a sub-embodiment of the foregoing embodiment, the transmit end of the first signal and the receive end of the target CSI are respectively different base stations.

In a sub-embodiment of the foregoing embodiment, the transmit end of the first signal is a wireless access point (AP), and the receive end of the target CSI is a mobile communication base station.

In an embodiment, the first node uses at least one of {an antenna, a receiver, a multi-antenna receiver processor, a receiver processor, a controller/processor, and a memory} used for the first wireless access technology to receive the first signal, and the first node uses at least one of {an antenna, a transmitter, a multi-antenna transmitter processor, a transmitter processor, a controller/processor, a memory, and a data source} used for the second wireless access technology to send the target CSI.

In an embodiment, the first node uses at least one of {an antenna, a receiver, a multi-antenna receiver processor, a receiver processor, a controller/processor, and a memory} used for the second wireless access technology to receive the first signal, and the first node uses at least one of {an antenna, a transmitter, a multi-antenna transmitter processor, a transmitter processor, a controller/processor, a memory, and a data source} used for the second wireless access technology to send the target CSI.

In an embodiment, the transmit end of the first signal uses at least one of {an antenna, a transmitter, a multi-antenna transmitter processor, a transmitter processor, a controller/processor, a memory, and a data source} used for the first wireless access technology to send the first signal, and the receive end of the target CSI uses at least one of {an antenna, a receiver, a multi-antenna receiver processor, a receiver processor, a controller/processor, and a memory} used for the second wireless access technology to receive the target CSI.

In an embodiment, the first signal is used for channel measurement, and the determining of the target CSI depends on measurement of the first signal; and the first wireless access technology is a cellular network wireless access technology.

In a sub-embodiment of the foregoing embodiment, the target CSI includes a target CQI, and determining of the target CQI depends on measurement of the first signal.

In a sub-embodiment of the foregoing embodiment, the determining of the target CSI depends on a first generator, and a result obtained by measuring the first signal is used for training of the first generator.

In a sub-embodiment of the foregoing embodiment, an input of a first generator depends on measurement of the first signal, the target CSI includes at least a part of an output corresponding to the input, and the first generator is obtained through training.

In an embodiment, the first signal is used for interference measurement, and the determining of the target CSI depends on measurement of the first signal; and the first wireless access technology is a cellular network wireless access technology.

In a sub-embodiment of the foregoing embodiment, the target CSI includes a target CQI, and determining of the target CQI depends on measurement of the first signal.

In a sub-embodiment of the foregoing embodiment, the determining of the target CSI depends on a first generator, and a result obtained by measuring the first signal is used for training of the first generator.

In a sub-embodiment of the foregoing embodiment, an input of a first generator depends on measurement of the first signal, the target CSI includes at least a part of an output corresponding to the input, and the first generator is obtained through training.

In an embodiment, the first signal is used for interference measurement, and the determining of the target CSI depends on measurement of the first signal; and the first wireless access technology is a non-cellular network wireless access technology.

In a sub-embodiment of the foregoing embodiment, the target CSI includes a target CQI, and determining of the target CQI depends on measurement of the first signal.

In a sub-embodiment of the foregoing embodiment, the determining of the target CSI depends on a first generator, and a result obtained by measuring the first signal is used for training of the first generator.

In a sub-embodiment of the foregoing embodiment, an input of a first generator depends on measurement of the first signal, the target CSI includes at least a part of an output corresponding to the input, and the first generator is obtained through training.

In an embodiment, the first node determines the target CSI.

### Embodiment 2

Embodiment 2 illustrates a flowchart of signal transmission according to an embodiment of this application, as shown in FIG. 2. In FIG. 2, the first node U1 and the second node U2 communicate with each other through an air interface.

The first node U1 receives a first signal of a first wireless access technology in step S211, and sends target CSI of a second wireless access technology in step S212.

The second node U2 sends the first signal of the first wireless access technology in step S221, and receives the target CSI of the second wireless access technology in step S222.

In Embodiment 2, the first wireless access technology is different from the second wireless access technology, and the second wireless access technology is a cellular network wireless access technology; the first signal is used for channel measurement, and determining of the target CSI depends on measurement of the first signal; and the first wireless access technology is a non-cellular network wireless access technology.

In a sub-embodiment of Embodiment 2, the target CSI includes a target CQI, and determining of the target CQI depends on measurement of the first signal.

In a sub-embodiment of Embodiment 2, the determining of the target CSI depends on a first generator, and a result obtained by measuring the first signal is used for training of the first generator.

In a sub-embodiment of Embodiment 2, an input of a first generator depends on measurement of the first signal, the target CSI includes at least a part of an output corresponding to the input, and the first generator is obtained through training.

In an embodiment, the first node U1 is the first node in this application.

In an embodiment, the second node U2 is the second node in this application.

In an embodiment, the first node U1 is UE.

In an embodiment, the second node U2 is a base station.

In an embodiment, the first node U1 is UE, and the second node U2 is a base station.

In an embodiment, the second node U2 is UE.

In an embodiment, the second node U2 is a wireless access point (AP).

In an embodiment, the air interface between the second node U2 and the first node U1 includes a Uu interface.

In an embodiment, the air interface between the second node U2 and the first node U1 includes a cellular link.

In an embodiment, the air interface between the second node U2 and the first node U1 includes a non-cellular link.

In an embodiment, the air interface between the second node U2 and the first node U1 includes a wireless local area network link.

In an embodiment, the air interface between the second node U2 and the first node U1 includes a WLAN link.

In an embodiment, the air interface between the second node U2 and the first node U1 includes a Wifi link.

In an embodiment, the air interface between the second node U2 and the first node U1 includes a Bluetooth link.

In an embodiment, the air interface between the second node U2 and the first node U1 includes a wireless interface between a base station device and a user equipment.

In an embodiment, the air interface between the second node U2 and the first node U includes a wireless interface between a satellite device and a user equipment.

In an embodiment, the air interface between the second node U2 and the first node U1 includes a wireless interface between a relay device and a user equipment.

In an embodiment, the air interface between the second node U2 and the first node U1 includes a wireless interface between a user equipment and a user equipment.

In an embodiment, the air interface between the second node U2 and the first node U1 includes a wireless interface between a wireless access point (AP) and a user equipment.

In an embodiment, the target CSI is determined at the first node.

### Embodiment 3

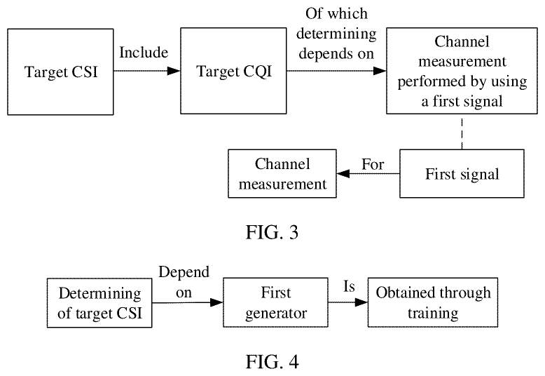

Embodiment 3 illustrates a schematic diagram of determining of target CSI depending on a first signal according to an embodiment of this application, as shown in FIG. 3.

In Embodiment 3, the target CSI includes a target CQI, the first signal is used for channel measurement, and determining of the target CQI depends on channel measurement performed by using the first signal.

In an embodiment, the target CQI indicates an expected MCS (modulation and coding scheme) under an assumed PDSCH transmission condition.

In an embodiment, the target CQI indicates the most efficient modulation manner and encoding rate that can be supported by a (virtual or actually unsent) PDSCH transmitted on a CSI reference resource under a BLER not exceeding 0.1.

Generally, how to determine the CQI based on signal measurement is implementation-specific, that is, left to individual vendors to determine. A typical but non-limiting implementation is described below:

The first node first measures at least one signal including the first signal, to obtain a raw channel matrix H_{r×t} where r,t are respectively a quantity of receive antennas and a quantity of antenna ports used for sending. Under the use of a precoding matrix W_{t×l}, an encoded channel parameter matrix is H_{r×t}·W_{t×l} where l is a quantity of ranks (rank) or layers. An equivalent channel capacity of H_{r×t}·W_{t×l} is calculated using criteria such as SINR (signal interference noise ratio), EESM (exponential effective SINR mapping), or RBIR (received block mean mutual information ratio). Further, calculation of the equivalent channel capacity may also take into account noise and interference estimated by the first node. If the at least one signal includes signals used for interference measurement, the first node may use these signals used for interference measurement to more accurately measure interference or noise. The target CQI is determined from the equivalent channel capacity through table lookup or the like.

In an embodiment, the at least one signal including the first signal includes only the first signal.

In an embodiment, the at least one signal including the first signal further includes a signal of the first wireless access technology.

In an embodiment, the at least one signal including the first signal further includes a signal of the second wireless access technology.

### Embodiment 4

Embodiment 4 illustrates a schematic diagram of determining of target CSI according to an embodiment of this application, as shown in FIG. 4.

In Embodiment 4, determining of the target CSI depends on a first generator, and the first generator is obtained by training.

In an embodiment, the first generator is used for compressing CSI.

In an embodiment, the first generator is used for channel estimation.

In an embodiment, the first generator is used for outputting at least a CQI.

In an embodiment, the first generator is used for outputting at least an SINR.

In an embodiment, the first generator is used for outputting at least precoding information.

In an embodiment, an input of the first generator includes data obtained through signal measurement.

In an embodiment, an input of the first generator includes to-be-compressed CSI data.

In an embodiment, the first generator includes an estimator.

In an embodiment, the first generator includes a Bayesian optimal estimator.

In an embodiment, the first generator includes a classifier.

In an embodiment, the first generator includes an encoder.

In an embodiment, the first generator is an encoder, including P0 encoding layers, namely, encoding layers #1, #2, . . . , and #P0.

In a sub-embodiment of the foregoing embodiment, P0 is 2, namely, the P0 encoding layers include an encoding layer #1 and an encoding layer #2. The encoding layer #1 and the encoding layer #2 are respectively a convolutional layer and a fully connected layer. In the convolutional layer, at least one convolution kernel is used to perform convolution on the input of the first generator to generate a corresponding feature map. At least one feature map output by the convolutional layer is reshaped (reshape) into a vector and input into the fully connected layer. The fully connected layer then transforms the vector into the output of the first generator. For more detailed description, refer to CNN-related technical literatures, such as Chao-Kai Wen, Deep Learning for Massive MIMO CSI Feedback, IEEE WIRELESS COMMUNICATIONS LETTERS, VOL.7,NO.5,OCTOBER 2018.

In a sub-embodiment of the foregoing embodiment, P0 is 3, that is, the P0 encoding layers include a fully connected layer, a convolutional layer, and a pooling layer.

In an embodiment, the determining of the target CSI depends on the first generator, and training of the first generator depends on measurement of the first signal.

In an embodiment, benefits of the method include: facilitating improvement of precision of CSI reporting by using an AI or ML technology.

In an embodiment, a training set used for training the first generator includes a result obtained by measuring the first signal.

In an embodiment, a training set used for training the first generator includes a raw channel matrix obtained by measuring at least one signal including the first signal.

In an embodiment, one piece of training data in the training set used for training the first generator is obtained by performing precoding based on the raw channel matrix obtained by measuring at least one signal including the first signal.

In an embodiment, the training set used for training the first generator includes interference estimation obtained by measuring the first signal.

In an embodiment, an input of a first generator depends on measurement of the first signal, the target CSI includes at least a part of an output corresponding to the input, and the first generator is obtained through training.

In an embodiment, benefits of the method include: facilitating improvement of precision of CSI reporting by using an AI or ML technology.

In an embodiment, the input of the first generator includes a result obtained by measuring the first signal.

In an embodiment, the input of the first generator includes a raw channel matrix obtained by measuring at least one signal including the first signal.

In an embodiment, the input of the first generator includes a result obtained by performing precoding based on a raw channel matrix obtained by measuring at least one signal including the first signal.

In an embodiment, the at least one signal including the first signal includes only the first signal.

In an embodiment, the at least one signal including the first signal further includes a signal of the first wireless access technology.

In an embodiment, the at least one signal including the first signal further includes a signal of the second wireless access technology.

In an embodiment, the input of the first generator includes interference estimation obtained by measuring the first signal.

In an embodiment, the target CSI includes at least a part of the output of the first generator.

In an embodiment, the at least a part of the output of the first generator serves as the CQI in the target CSI.

In an embodiment, the at least a part of the output of the first generator serves as the SINR in the target CSI.

In an embodiment, the at least a part of the output of the first generator serves as precoding information in the target CSI.

In an embodiment, the at least a part of the output of the first generator serves as a channel estimated value in the target CSI.

### Embodiment 5

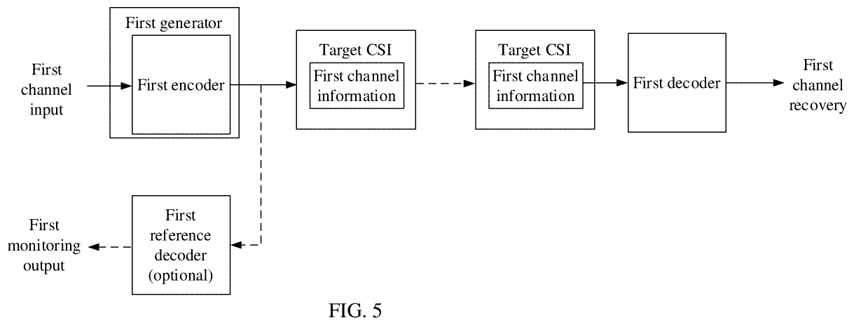

FIG. 5 illustrates a flowchart of transmission of first channel information included in target CSI according to an embodiment of this application, as shown in FIG. 5. In FIG. 5, a first reference decoder is optional.

In Embodiment 5, a first encoder and the first reference decoder belong to a first node, and a first decoder belongs to a second node.

In Embodiment 5, a first generator includes the first encoder. First channel information is generated from a first channel input by using the first encoder. The target CSI includes the first channel information. The first encoder is obtained through training. The second node uses the first decoder to generate first channel recovery, where an input of the first decoder includes the first channel information, and the first decoder is obtained through training.

The first encoder and the first decoder should theoretically be inverse operations of each other to ensure that the first channel input is identical to the first channel recovery.

In an embodiment, due to factors such as implementation complexity, implementation fairness, air interface overhead, or latency, the first encoder and the first decoder in Embodiment 5 cannot guarantee complete cancellation. Therefore, the first channel input and the first channel recovery cannot be ensured to be identical.

In an embodiment, the first generator is the first encoder.

In an embodiment, a training set used for training the first encoder includes a result of measurement of the first signal.

In an embodiment, a training set used for training the first encoder includes a raw channel matrix obtained by measuring at least one signal including the first signal.

In an embodiment, one piece of training data in the training set used for training the first encoder is obtained by performing precoding based on the raw channel matrix obtained by measuring at least one signal including the first signal.

In an embodiment, the first channel input depends on measurement of the first signal.

In an embodiment, the first channel input is a raw channel matrix obtained through measurement.

In an embodiment, the first channel input is obtained by performing precoding based on a raw channel matrix obtained through measurement.

In an embodiment, the first channel input is a raw channel matrix obtained by measuring at least one signal including the first signal.

In an embodiment, the first channel input is obtained by performing precoding based on a raw channel matrix obtained by measuring at least one signal including the first signal.

In an embodiment, the first receiving apparatus further includes the first reference decoder, an input of the first reference decoder includes the first channel information, and an output of the first reference decoder includes a first monitoring output.

In an embodiment, a difference between the first channel input and the first monitoring output is used by the first node to determine whether the first encoder needs to be updated.

In the foregoing embodiment, the first reference decoder and the first decoder may be independently generated or independently maintained. Therefore, although both aim to perform an inverse operation of the first encoder, the first reference decoder and the first decoder may only be approximate to each other.

In an embodiment, the training of the first encoder is performed by the first node.

In an embodiment, the training of the first encoder is performed by the second node, and the second node configures the first encoder to the first node.

In an embodiment, the training of the first decoder is performed by the second node.

In an embodiment, the training of the first decoder is performed by the first node, and the first node reports the first encoder to the second node.

### Embodiment 6

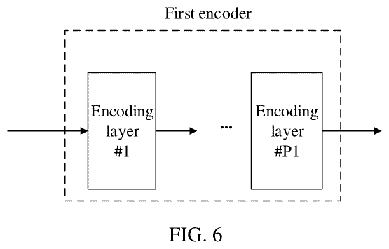

Embodiment 6 illustrates a schematic diagram of a first encoder according to an embodiment of this application, as shown in FIG. 6. In FIG. 6, the first encoder includes P1 encoding layers, namely, encoding layers #1, #2, . . . , and #P1.

In an embodiment, P1 is 2, that is, the P1 encoding layers include an encoding layer #1 and an encoding layer #2. The encoding layer #1 and the encoding layer #2 are respectively a convolutional layer and a fully connected layer. In the convolutional layer, at least one convolution kernel is used to perform convolution on a first channel input to generate a corresponding feature map. At least one feature map output by the convolutional layer is reshaped (reshape) into a vector and input into the fully connected layer. The fully connected layer then transforms the vector into first channel information. For more detailed description, refer to CNN-related technical literatures, such as Chao-Kai Wen, Deep Learning for Massive MIMO CSI Feedback, IEEE WIRELESS COMMUNICATIONS LETTERS, VOL. 7, NO. 5, OCTOBER 2018.

In an embodiment, P1 is 3, that is, the P1 encoding layers include a fully connected layer, a convolutional layer, and a pooling layer.

### Embodiment 7

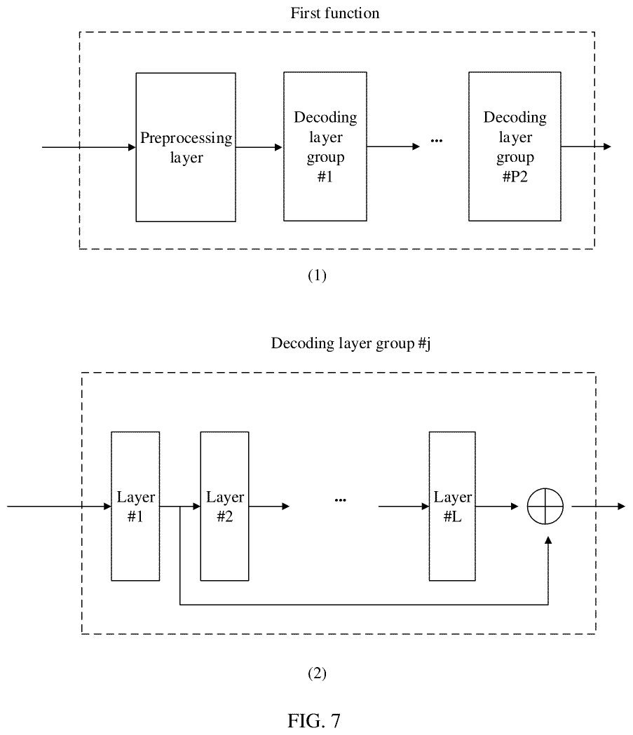

Embodiment 7 illustrates a schematic diagram of a first function according to an embodiment of this application, as shown in FIG. 7. In (1) of FIG. 7, the first function includes a preprocessing layer and P2 decoding layer groups, namely, decoding layer groups #1, #2, . . . , and #P2, where each decoding layer group includes at least one decoding layer. In (2) of FIG. 7, a decoding layer group #j includes L layers, namely, layers #1, #2, . . . , and #L. The decoding layer group #j is any one of the P2 decoding layer groups.

A structure of the first function is suitable for the first decoder and the first reference decoder in Embodiment 5.

In an embodiment, the preprocessing layer is a fully connected layer, and a size of first channel information is expanded to a size of a first channel input.

In an embodiment, structures of any two decoding layer groups in the P2 decoding layer groups are identical, and the structure includes a quantity of included decoding layers, a size of an input parameter and a size of an output parameter of each included decoding layer, and the like.

In an embodiment, the second node indicates the structures of the P2 decoding layer groups to the first node.

In an embodiment, L is 4, a first layer in the L layers is an input layer, and the remaining layers in the L layers are convolutional layers. For more detailed description, refer to CNN-related technical literatures, such as Chao-Kai Wen, Deep Learning for Massive MIMO CSI Feedback, IEEE WIRELESS COMMUNICATIONS LETTERS, VOL. 7, NO. 5, OCTOBER 2018.

In an embodiment, the L layers include at least one convolutional layer and one pooling layer.

### Embodiment 8

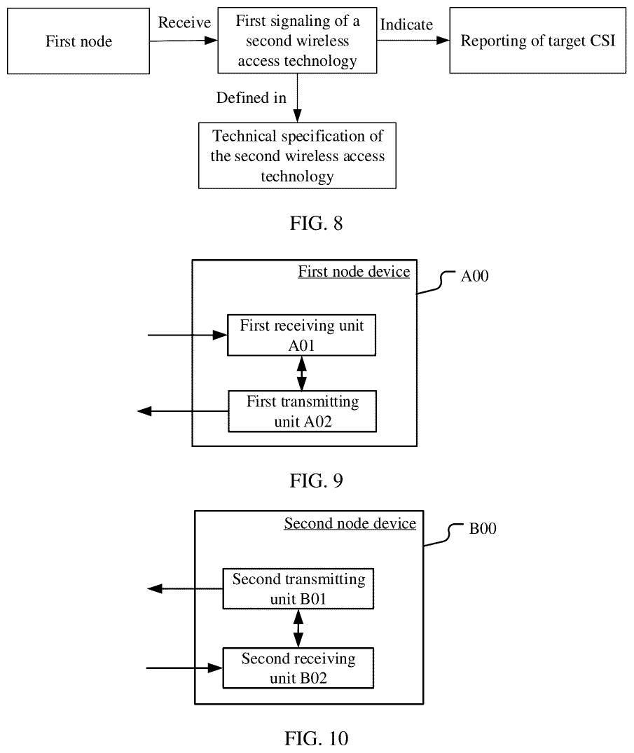

Embodiment 8 illustrates a schematic diagram of first signaling according to an embodiment of this application, as shown in FIG. 8.

In Embodiment 8, the first node receives first signaling of a second wireless access technology, the first signaling indicates reporting of the target CSI, and the first signaling is defined in technical specification of the second wireless access technology.

In an embodiment, the first signaling is signaling from a physical layer.

In an embodiment, the first signaling is DCI.

In an embodiment, the first signaling is signaling from a higher layer.

In an embodiment, the higher layer includes a layer above the physical layer.

In an embodiment, the higher layer includes a MAC layer.

In an embodiment, the higher layer includes an RRC layer.

In an embodiment, reception of the first signal is before reception of the first signal.

In an embodiment, reception of the first signal is after reception of the first signal.

In an embodiment, a transmit end of the first signaling and a receive end of the target CSI are a same node.

In an embodiment, the first node uses at least one of {an antenna, a receiver, a multi-antenna receiver processor, a receiver processor, a controller/processor, and a memory} used for the second wireless access technology to receive the first signaling, and the transmit end of the first signaling uses at least one of {an antenna, a transmitter, a multi-antenna transmitter processor, a transmitter processor, a controller/processor, a memory, and a data source} used for the second wireless access technology to send the first signaling.

### Embodiment 9

Embodiment 9 illustrates a block diagram of a structure of a processing apparatus in a first node device, as shown in FIG. 9. In FIG. 9, a processing apparatus A00 in the first node device includes a first receiving apparatus A01 and a first transmitting apparatus A02.

In an embodiment, the first node device A00 is a user equipment.

In an embodiment, the first node device A00 is a relay node.

In an embodiment, the first node device A00 is a vehicle-mounted communication device.

In an embodiment, the first receiving apparatus A01 includes at least one of {an antenna, a receiver, a multi-antenna receiver processor, a receiver processor, a controller/processor, and a memory} used for the first wireless access technology.

In an embodiment, the first receiving apparatus A01 includes at least first two of {an antenna, a receiver, a multi-antenna receiver processor, a receiver processor, a controller/processor, and a memory} used for the first wireless access technology.

In an embodiment, the first receiving apparatus A01 includes at least one of {an antenna, a receiver, a multi-antenna receiver processor, a receiver processor, a controller/processor, and a memory} used for the second wireless access technology.

In an embodiment, the first receiving apparatus A01 includes at least first two of {an antenna, a receiver, a multi-antenna receiver processor, a receiver processor, a controller/processor, and a memory} used for the second wireless access technology.

In an embodiment, the first transmitting apparatus A02 includes at least one of {an antenna, a transmitter, a multi-antenna transmitter processor, a transmitter processor, a controller/processor, a memory, and a data source} used for the second wireless access technology.

In an embodiment, the first transmitting apparatus A02 includes at least first two of {an antenna, a transmitter, a multi-antenna transmitter processor, a transmitter processor, a controller/processor, a memory, and a data source} used for the second wireless access technology.

In an embodiment, the first receiving apparatus A01 receives a first signal of the first wireless access technology, and the first transmitting apparatus A02 sends target CSI of the second wireless access technology, where determining of the target CSI depends on the first signal, the first wireless access technology is different from the second wireless access technology, and the second wireless access technology is a cellular network wireless access technology.

In an embodiment, the target CSI includes a target CQI, and determining of the target CQI depends on measurement of the first signal.

In an embodiment, the first signal is used for channel measurement, and the determining of the target CSI depends on measurement of the first signal.

In an embodiment, the determining of the target CSI depends on a first generator, and a result obtained by measuring the first signal is used for training of the first generator.

In an embodiment, an input of a first generator depends on measurement of the first signal, the target CSI includes at least a part of an output corresponding to the input, and the first generator is obtained through training.

In an embodiment, the first receiving apparatus A01 receives first signaling of the second wireless access technology, and the first signaling indicates reporting of the target CSI.

In an embodiment, the first wireless access technology is a non-cellular network wireless access technology.

### Embodiment 10

Embodiment 10 illustrates a block diagram of a structure of a processing apparatus in a second node device, as shown in FIG. 10. In FIG. 10, a processing apparatus B00 in the second node device includes a second transmitting apparatus B01 and a second receiving apparatus B02.

In an embodiment, the second node device B00 is a user equipment.

In an embodiment, the second node device B00 is a vehicle-mounted communication device.

In an embodiment, the second node device B00 is a wireless access point.

In an embodiment, the second node device B00 is base station.

In an embodiment, the second node device B00 is a satellite device.

In an embodiment, the second node device B00 is a relay node.

In an embodiment, the second node device B00 is one of a test apparatus, a test device, and a test instrument.

In an embodiment, the second transmitting apparatus B01 includes at least one of {an antenna, a transmitter, a multi-antenna transmitter processor, a transmitter processor, a controller/processor, a memory, and a data source} used for the first wireless access technology.

In an embodiment, the second transmitting apparatus B01 includes at least first two of {an antenna, a transmitter, a multi-antenna transmitter processor, a transmitter processor, a controller/processor, a memory, and a data source} used for the first wireless access technology.

In an embodiment, the second receiving apparatus B02 includes at least one of {an antenna, a receiver, a multi-antenna receiver processor, a receiver processor, a controller/processor, and a memory} used for the second wireless access technology.

In an embodiment, the second receiving apparatus B02 includes at least first two of {an antenna, a receiver, a multi-antenna receiver processor, a receiver processor, a controller/processor, and a memory} used for the second wireless access technology.

In an embodiment, the second transmitting apparatus B01 sends a first signal of the first wireless access technology, and the second receiving apparatus B02 receives target CSI of the second wireless access technology, where determining of the target CSI depends on the first signal, the first wireless access technology is different from the second wireless access technology, and the second wireless access technology is a cellular network wireless access technology.

In an embodiment, the target CSI includes a target CQI, and determining of the target CQI depends on measurement of the first signal.

In an embodiment, the first signal is used for channel measurement, and the determining of the target CSI depends on measurement of the first signal.

In an embodiment, the determining of the target CSI depends on a first generator, and a result obtained by measuring the first signal is used for training of the first generator.

In an embodiment, an input of a first generator depends on measurement of the first signal, the target CSI includes at least a part of an output corresponding to the input, and the first generator is obtained through training.

In an embodiment, the second transmitting apparatus B01 sends first signaling of the second wireless access technology, and the first signaling indicates reporting of the target CSI.

In an embodiment, the first wireless access technology is a non-cellular network wireless access technology.

A person of ordinary skill in the art may understand that all or part of the steps of the foregoing methods may be implemented by a program instructing relevant hardware. The program may be stored in a non-transitory computer-readable storage medium, such as a read-only memory, a hard disk, or an optical disk. Optionally, all or part of the steps of the foregoing embodiments may also be implemented using one or more integrated circuits. Correspondingly, each module unit in the foregoing embodiments may be implemented in a form of hardware, or may be implemented in a form of a software functional module. This application is not limited to any specific combination of software and hardware. The first node device in this application includes, but is not limited to, a wireless communication device such as a mobile phone, a tablet computer, a notebook computer, a USB dongle, a low-power device, an eMTC device, an NB-IoT device, a vehicle-mounted communication device, an aircraft, an airplane, a drone, or a remote-controlled aircraft. The second node device in this application includes, but is not limited to, a wireless communication device such as a mobile phone, a tablet computer, a notebook computer, a USB dongle, a low-power device, an eMTC device, an NB-IoT device, a vehicle-mounted communication device, an aircraft, an airplane, a drone, or a remote-controlled aircraft. The user equipment or UE or terminal in this application includes, but is not limited to, a wireless communication device such as a mobile phone, a tablet computer, a notebook computer, a USB dongle, a low-power device, an eMTC device, an NB-IoT device, a vehicle-mounted communication device, an aircraft, an airplane, a drone, or a remote-controlled aircraft. The base station device or base station or network-side device in this application includes, but is not limited to, a device such as a macrocell base station, a microcell base station, a femtocell, a relay base station, an eNB, a gNB, a transmission-reception point TRP, a GNSS, a relay satellite, a satellite base station, an aerial base station, a test apparatus, a test device, or a test instrument.

A person skilled in the art should understand that the present invention may be implemented in other specific forms without departing from essential or basic characteristics thereof. Therefore, the currently disclosed embodiments should in no way be regarded as restrictive, but rather as illustrative. The scope of the present invention is defined by the appended claims rather than by the foregoing description, and all modifications falling within the equivalent meaning and range thereof are considered to be included therein.

1. A first node used for wireless communication, the first node comprising:
a first receiving apparatus, configured to receive a first signal of a first wireless access technology; and
a first transmitting apparatus, configured to send target channel state information (CSI) of a second wireless access technology, wherein
determining of the target CSI depends on the first signal, the first wireless access technology is different from the second wireless access technology, and the second wireless access technology is a cellular network wireless access technology.

2. The first node according to claim 1, wherein the target CSI comprises a target_channel quality indicator (CQI), and determining of the target CQI depends on measurement of the first signal.

3. The first node according to claim 1, wherein the first signal is used for channel measurement, and determining of the target CSI depends on measurement of the first signal.

4. The first node according to claim 1, wherein determining of the target CSI depends on a first generator, and a result obtained by measuring the first signal is used for training of the first generator.

5. The first node according to claim 1, wherein an input of a first generator depends on measurement of the first signal, the target CSI comprises at least a part of an output corresponding to the input, and the first generator is obtained through training.

6. The first node according to claim 1, wherein the first receiving apparatus receives first signaling of the second wireless access technology, and the first signaling indicates reporting of the target CSI.

7. The first node according to claim 1, wherein the first wireless access technology is a non-cellular network wireless access technology.

8. A second node used for wireless communication, the second node comprising:
a second transmitting apparatus, configured to send a first signal of a first wireless access technology; and
a second receiving apparatus, configured to receive target channel state information (CSI) of a second wireless access technology, wherein
determining of the target CSI depends on the first signal, the first wireless access technology is different from the second wireless access technology, and the second wireless access technology is a cellular network wireless access technology.

9. The second node according to claim 8, wherein the target CSI includes a target channel quality indicator (CQI), and determining of the target CQI depends on measurement of the first signal.

10. The second node according to claim 8, wherein the first signal is used for channel measurement, and determining of the target CSI depends on measurement of the first signal.

11. The second node according to claim 8, wherein determining of the target CSI depends on a first generator, and a result obtained by measuring the first signal is used for training of the first generator.

12. The second node according to claim 8, wherein an input of a first generator depends on measurement of the first signal, the target CSI includes at least a part of an output corresponding to the input, and the first generator is obtained through training.

13. The second node according to claim 8, wherein first signaling of the second wireless access technology is sent, and the first signaling indicates reporting of the target CSI.

14. The second node according to claim 8, wherein the first wireless access technology is a non-cellular network wireless access technology.

15. A method in a first node used for wireless communication, the method comprising:
receiving a first signal of a first wireless access technology; and
sending target channel state information (CSI) of a second wireless access technology, wherein
determining of the target CSI depends on the first signal, the first wireless access technology is different from the second wireless access technology, and the second wireless access technology is a cellular network wireless access technology.

16. The method according to claim 15, wherein the target CSI comprises a target channel quality indicator (CQI), and determining of the target CQI depends on measurement of the first signal.

17. The method according to claim 15, wherein the first signal is used for channel measurement, and determining of the target CSI depends on measurement of the first signal.

18. The method according to claim 15, wherein determining of the target CSI depends on a first generator, and a result obtained by measuring the first signal is used for training of the first generator.

19. The method according to claim 15, wherein an input of a first generator depends on measurement of the first signal, the target CSI comprises at least a part of an output corresponding to the input, and the first generator is obtained through training.

20. The method according to claim 15, wherein the first receiving apparatus receives first signaling of the second wireless access technology, and the first signaling indicates reporting of the target CSI.
